(19) United States
(12) Patent Application Publication
(10) Pub. No.: US 2018/0314129 A1
(43) Pub. Date: Nov. 1, 2018

(54) LIQUID CRYSTAL LENS

(71) Applicant: Nippon Electric Glass Co., Ltd., Shiga (JP)

(72) Inventors: Kazuyuki KIKUCHI, Shiga (JP); Takashi AKIMOTO, Shiga (JP); Tomio MURAKAMI, Shiga (JP)

(21) Appl. No.: 15/770,240

(22) PCT Filed: Jul. 12, 2016
(86) PCT No.: PCT/JP2016/070562

§ 371 Date: Apr. 23, 2018

(30) Foreign Application Priority Data
Oct. 30, 2015 (JP) 2015-214446

(51) Int. Cl. G02F 1/29

(52) U.S. Cl. CPC G02F 1/29; G02F 2001/294; G02F 2201/122

(57) ABSTRACT

A liquid crystal lens includes a first electrode including a first electrode portion having a circular opening and a second electrode portion arranged on an inner side of the opening, a second electrode opposed to the first electrode, a liquid crystal layer formed between the first electrode and the second electrode, and power supplies configured to apply an AC voltage to the first and second electrodes. The power supplies include a first power supply configured to apply a first rectangular wave voltage to the first electrode portion, a second power supply configured to apply a second rectangular wave voltage with a phase identical to that of the first voltage to the second electrode portion, and a third power supply configured to apply a third rectangular wave voltage with a phase different from those of the first and second voltages by 180° to the second electrode.

### TECHNICAL FIELD

The present invention relates to an improved technology of a liquid crystal lens.

### BACKGROUND ART

A liquid crystal lens is a device in which a voltage is applied to a liquid crystal layer in which liquid crystal molecules are aligned in one direction and alignment of the liquid crystal molecules are controlled so that a refractive index is changed. The liquid crystal lens has a feature of being capable of varying a focal distance without a mechanical drive unit, such as a motor.

As disclosed in Patent Literature 1, a related-art liquid crystal lens mainly includes a first substrate (first main wall portion) including a first electrode, a second substrate (second main wall portion) including a second electrode opposed to the first electrode, and a liquid crystal layer formed between the first electrode and the second electrode. Further, the liquid crystal lens includes a high-resistance film (high-resistance layer) between the first electrode and the liquid crystal layer (see paragraph [0026] and the like of Patent Literature 1).

The first electrode includes a first electrode portion having a circular opening and a second electrode portion arranged inside the opening. A predetermined voltage (V1) is applied between the first electrode portion of the first electrode on the first substrate and the second electrode on the second substrate. Further, a predetermined voltage (V2) is separately applied between the second electrode portion of the first electrode and the second electrode. The second electrode is set to a ground electrode (see paragraphs [0024] and [0025] and FIG. 1 of Patent Literature 1).

The liquid crystal lens having the above-mentioned configuration brings about an alignment effect in liquid crystal molecules contained in the liquid crystal layer with an axially symmetric non-uniform electric field generated between the first electrode and the second electrode, to thereby obtain a paraboloidal refractive index distribution. Further, the liquid crystal lens suitably generates the axially symmetric non-uniform electric field through a relay effect of a potential distribution as a result of occurrence of dielectric coupling through the high-resistance film. With this, the liquid crystal lens can be driven with a low voltage.

### CITATION LIST

Patent Literature 1: JP 2014-35470 A

### SUMMARY OF INVENTION

### Technical Problem

The related-art liquid crystal lens is configured so as to be driven with a low voltage through use of the high-resistance film. However, in recent years, there has been a demand for implementation of a liquid crystal lens for which a drive voltage is further reduced.

The present invention has been made in view of the above-mentioned circumstance, and it is an object of the present invention to provide a liquid crystal lens for which a drive voltage can be reduced.

### Solution to Problem

The present invention has been made in order to solve the above-mentioned problem, and according to one embodiment of the present invention, there is provided a liquid crystal lens comprising: a first electrode comprising a first electrode portion having a circular opening and a second electrode portion arranged on an inner side of the circular opening; a second electrode opposed to the first electrode; a liquid crystal layer formed between the first electrode and the second electrode; and power supplies configured to apply an AC voltage to the first electrode and the second electrode, the power supplies comprising: a first power supply configured to apply a voltage having a first rectangular wave to the first electrode portion; a second power supply configured to apply a voltage having a second rectangular wave with a phase identical to a phase of the first rectangular wave to the second electrode portion; and a third power supply configured to apply a voltage having a third rectangular wave with a phase different from the phase of the first rectangular wave and the phase of the second rectangular wave by 180° to the second electrode.

With the above-mentioned configuration, the drive voltage for the liquid crystal lens can be reduced to the extent possible by inverting the phase of the third rectangular wave with respect to those of the first rectangular wave and the second rectangular wave. That is, when a voltage in the first electrode portion is represented by V1, a voltage in the second electrode portion is represented by V2, and a voltage having the third rectangular wave with the inverted phase is represented by V3, a difference between the voltage in the first electrode portion and the voltage in the second electrode can be represented by V1-V3. Similarly, a difference between the voltage in the second electrode portion and the voltage in the second electrode can be represented by V2-V3. That is, as compared to the case in which the second electrode is set to the ground electrode as in the related art, the voltage between the first electrode and the second electrode can be reduced by applying the voltage V3 having the third rectangular wave with the inverted phase to the second electrode through use of the third power supply. With this, only the drive voltage for the liquid crystal lens can be reduced without decreasing the optical power thereof.

Further, it is desired that the liquid crystal lens according to one embodiment of the present invention further comprise a high-resistance film formed between the first electrode and the liquid crystal layer. The liquid crystal lens according to one embodiment of the present invention is not limited thereto. The liquid crystal lens is not required to comprise the high-resistance film, and may have a configuration in which a substrate comprising the first electrode is further included and the substrate is interposed between the first electrode and the second electrode.

### Advantageous Effects of Invention

According to the present invention, the liquid crystal lens can be driven with a voltage lower than that of the related art.

### BRIEF DESCRIPTION OF DRAWINGS

FIG. 1 is a sectional view of a liquid crystal lens according to a first embodiment of the present invention.

FIG. 2 is a plan view for illustrating a first electrode in the liquid crystal lens.

FIG. 3A is a graph for showing a waveform of a voltage applied to each electrode.

FIG. 3B is a graph for showing a waveform of a voltage applied to each electrode.

FIG. 3C is a graph for showing a waveform of a voltage applied to each electrode.

FIG. 4 is a sectional view of a liquid crystal lens according to a second embodiment of the present invention.

### DESCRIPTION OF EMBODIMENTS

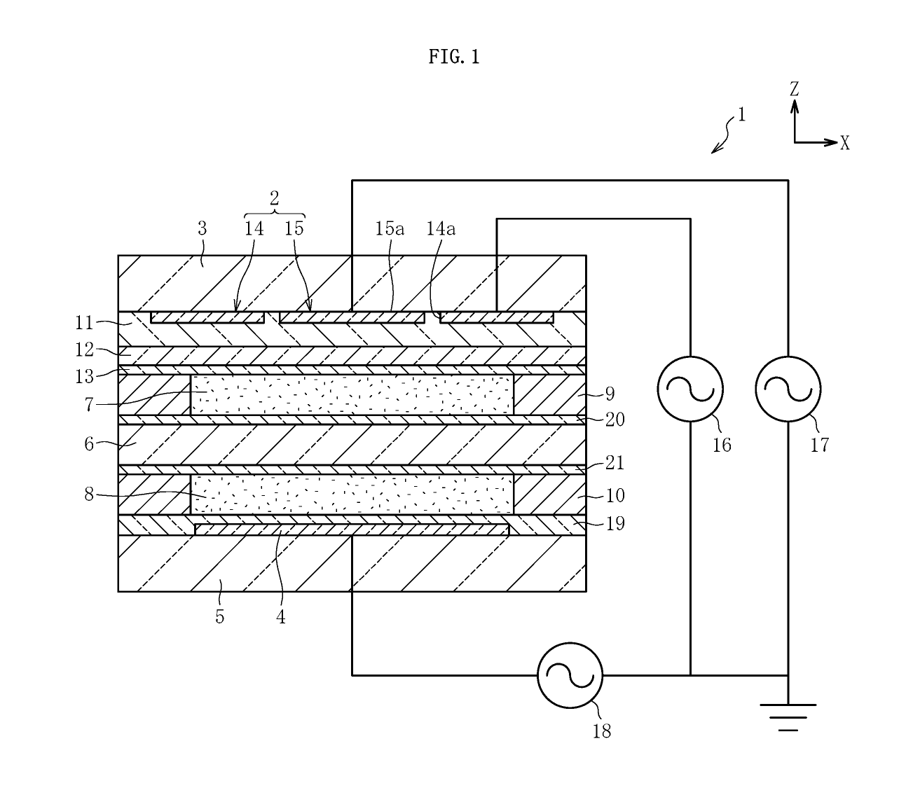

Now, modes for carrying out the present invention are described with reference to the drawings. In FIG. 1 to FIGS. 3, a liquid crystal lens according to a first embodiment of the present invention is illustrated.

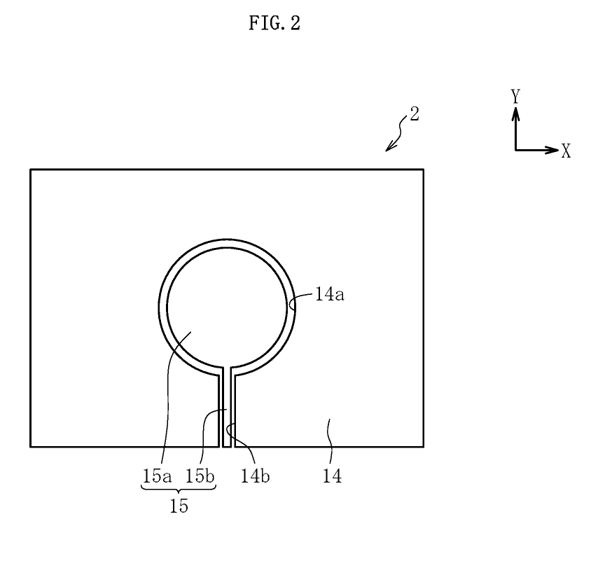

As illustrated in FIG. 1 and FIG. 2, a liquid crystal lens 1 comprises a first substrate 3 comprising a first electrode 2, a second substrate 5 comprising a second electrode 4 opposed to the first substrate 3, and a third substrate 6 interposed between the first substrate 3 and the second substrate 5. Further, the liquid crystal lens 1 comprises a first liquid crystal layer 7 interposed between the first substrate 3 and the third substrate 6 and a second liquid crystal layer 8 interposed between the second substrate 5 and the third substrate 6. Further, the liquid crystal lens 1 comprises a first spacer 9 interposed between the first substrate 3 and the third substrate 6 and a second spacer 10 interposed between the second substrate 5 and the third substrate 6.

The first substrate 3 is formed of a transparent glass sheet, but is not limited thereto. The first substrate 3 comprises, in addition to the first electrode 2, an insulating film 11 covering the first electrode 2, a high-resistance film 12 laminated on the insulating film 11, and an alignment film 13 laminated on the high-resistance film 12.

The first electrode 2 is formed into a rectangular shape in plan view, and is formed on one surface of the first substrate 3. The first electrode 2 has a transparent conductive oxide, for example, indium tin oxide (ITO), firmly fixed to the first electrode 2 by a deposition method, a sputtering method, or other methods, but the shape and material of the first electrode 2 are not limited thereto.

As illustrated in FIG. 1 and FIG. 2, the first electrode 2 comprises a first electrode portion 14 and a second electrode portion 15. The first electrode portion 14 has a circular opening 14a and a linear communication port 14b, which causes the opening 14a to communicate to an outer edge portion of the first electrode portion 14. The opening 14a and the communication port 14b are used for arranging the second electrode portion 15 on an inner side of the first electrode portion 14.

As illustrated in FIG. 1, the first electrode portion 14 is connected to a power supply (hereinafter referred to as “first power supply”) 16 configured to apply an AC voltage. The first power supply 16 is connected to a part of the outer edge portion of the first electrode portion 14. A voltage having a predetermined AC waveform is applied to the first electrode portion 14 by the first power supply 16.

As illustrated in FIG. 2, the second electrode portion 15 comprises a body portion 15a formed into a circular shape and a terminal portion 15b formed integrally with the body portion 15a. The body portion 15a is formed on an inner side of the opening 14a of the first electrode portion 14. The body portion 15a is formed so as to have a diameter slightly smaller than that of the opening 14a, and is not held in contact with the first electrode portion 14. The terminal portion 15b is a linear portion protruding radially outward from a part of the body portion 15a. The terminal portion 15b is arranged on an inner side of the communication port 14b of the first electrode portion 14. The terminal portion 15b is formed so as to have a width dimension slightly smaller than that of the communication port 14b, and is not held in contact with the first electrode portion 14.

As illustrated in FIG. 1, the second electrode portion 15 is connected to an AC power supply (hereinafter referred to as “second power supply”) 17, which is independent from the first power supply 16. The second power supply 17 is connected to the terminal portion 15b of the second electrode portion 15. A voltage having a predetermined AC waveform is applied to the second electrode portion 15 by the second power supply 17.

The insulating film 11 is a film transparent to visible light. The insulating film 11 is formed of an oxide, for example, SiO₂. Alternatively, the insulating film 11 may be formed of a non-oxide, for example, a nitride such as AlN or SiN, a fluoride such as MgF₂ or CF₂, and a sulfide such as ZnS. The insulating film 11 insulates the first electrode 2 and the second electrode 4 from each other by covering the first electrode portion 14 and the second electrode portion 15.

The insulating film 11 has a thickness of preferably from 300 nm to 1,000 nm, more preferably from 300 nm to 600 nm, most preferably from 300 nm to 400 nm. When the thickness of the insulating film 11 is smaller than 300 nm, there is a risk in that puncture may occur between the first electrode 2 and the high-resistance film 12. When the thickness of the insulating film 11 is larger than 1,000 nm, there is a risk in that an electric field formed between the first electrode 2 and the second electrode 4 may not sufficiently act on each of the liquid crystal layers 7 and 8.

The high-resistance film 12 is used for causing an axially symmetric electric field to be suitably generated up to a center portion of the opening 14a of the first electrode portion 14. It is preferred that the high-resistance film 12 contain at least one kind of zinc oxide, aluminum zinc oxide, indium tin oxide, antimony tin oxide, gallium zinc oxide, silicon zinc oxide, tin zinc oxide, boron zinc oxide, and germanium zinc oxide. The high-resistance film 12 is not limited thereto. When the insulating film 11 is formed of a non-oxide, it is desired that the high-resistance film 12 be formed of, for example, indium gallium zinc oxide (IGZO) in order to stabilize a resistance value of the high-resistance film 12.

The high-resistance film 12 has a thickness of preferably from 20 nm to 1,000 nm, more preferably from 50 nm to 500 nm, most preferably from 70 nm to 200 nm. In any of the case in which the thickness of the high-resistance film 12 is smaller than 20 nm and the case in which the thickness of the high-resistance film 12 is larger than 1,000 nm, there is a risk in that the high-resistance film 12 may not be able to exhibit its function sufficiently.

The high-resistance film 12 has a sheet resistance of preferably from 100 kΩ/square to 100 GΩ/square, more preferably from 500 kΩ/square to 10 GΩ/square, most preferably from 1 MΩ/square to 1 GΩ/square. In any of a case in which the sheet resistance of the high-resistance film 12 is smaller than 100 kΩ/square and a case in which the sheet resistance of the high-resistance film 12 is larger than 100 GΩ/square, there is a risk in that the high-resistance film 12 may not be able to exhibit its function sufficiently.

The alignment film 13 may be formed of, for example, a polyimide film having minute groove portions formed by rubbing treatment, but the alignment film 13 is not limited thereto. Liquid crystal molecules contained in the first liquid crystal layer 7 may be aligned at a pretilt angle through action of the alignment film 13.

The second substrate 5 is formed of a transparent glass sheet, but is not limited thereto. The second substrate 5 is arranged so that the second electrode 4 fixed to one surface thereof is opposed to the first electrode 2 on the first substrate 3.

The second electrode 4 formed on the second substrate 5 is formed into a rectangular shape in plan view in the same manner as in the first electrode 2. The second electrode 4 has a transparent conductive oxide, for example, indium tin oxide (ITO), firmly fixed to the first electrode 2 by the deposition method, the sputtering method, or other methods, but the second electrode 4 is not limited thereto.

The second electrode 4 is connected to an AC power supply (hereinafter referred to as “third power supply”) 18, which is independent from the first power supply 16 and the second power supply 17. The third power supply 18 is connected to a part of an outer edge portion of the second electrode 4. A voltage having a predetermined AC waveform is applied to the second electrode 4 by the third power supply 18.

The second substrate 5 comprises, in addition to the second electrode 4, an alignment film 19 formed so as to face the second liquid crystal layer 8. The alignment film 19 is laminated so as to cover the second electrode 4. The alignment film 19 may be formed of, for example, a polyimide film subjected to rubbing treatment, but is not limited thereto. Liquid crystal molecules contained in the second liquid crystal layer 8 are aligned at a pretilt angle through action of the alignment film 19.

The third substrate 6 is formed of a transparent glass sheet, but is not limited thereto. The third substrate 6 has the same shape and substantially the same area as those of the first substrate 3 and the second substrate 5. The third substrate 6 has alignment films 20 and 21 on both surfaces thereof. One alignment film 20 faces the first liquid crystal layer 7, and the other alignment film 21 faces the second liquid crystal layer 8. Each of the alignment films 20 and 21 may be formed of a polyimide film subjected to rubbing treatment in the same manner as in the alignment film 13 of the first substrate 3 and the alignment film 19 of the second substrate 5, but is not limited thereto. The liquid crystal molecules contained in each of the liquid crystal layers 7 and 8 are aligned at a pretilt angle through action of the alignment films 20 and 21.

The first liquid crystal layer 7 accommodates a homogeneous liquid crystal in a space partitioned by the first substrate 3, the third substrate 6, and the first spacer 9. Further, the second liquid crystal layer 8 accommodates a homogeneous liquid crystal in a space partitioned by the second substrate 5, the third substrate 6, and the second spacer 10. Each of the liquid crystal layers 7 and 8 has the liquid crystal molecules aligned at a predetermined tilt angle through action of an electric field generated by application of the voltage with each of the power supplies 16 to 18.

The first spacer 9 and the second spacer 10 are each made of a metal and formed as an annular plate member through use of aluminum, for example. However, the first spacer 9 and the second spacer 10 are not limited thereto. The thickness of each of the spacers 9 and 10 can be suitably set in accordance with the thickness of each of the liquid crystal layers 7 and 8 and the response speed and the like required of each of the liquid crystal layers 7 and 8. The thickness of each of the spacers 9 and 10 can be set to, for example, from about 10 μm to about 80 μm.

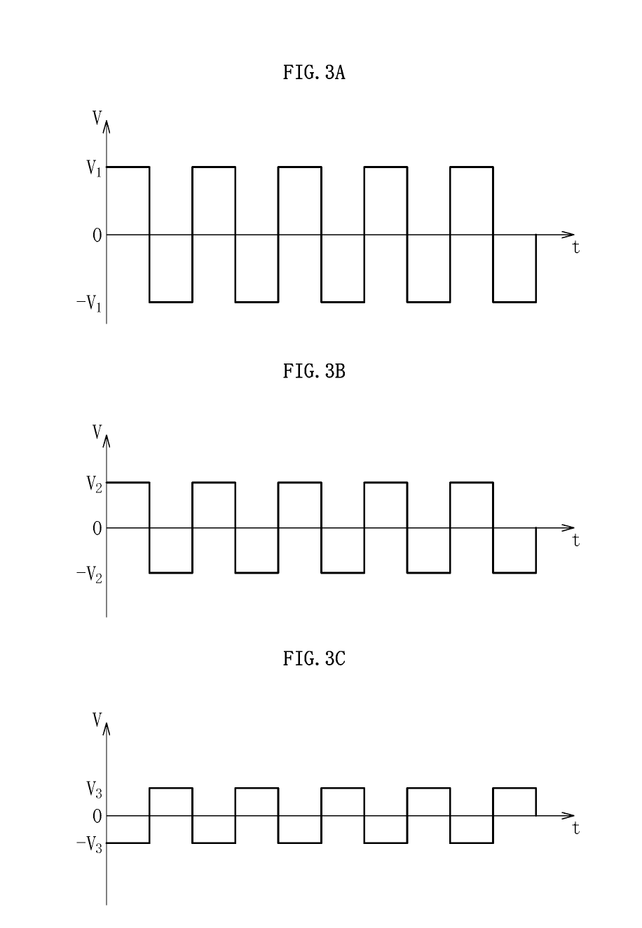

Now, an operation of the liquid crystal lens 1 having the above-mentioned configuration is described with reference to FIGS. 3. In the liquid crystal lens 1 according to the first embodiment, as shown in FIG. 3A, a voltage (potential) having a rectangular wave (hereinafter referred to as “first rectangular wave”) with an amplitude V1 is applied to the first electrode portion 14. Further, as shown in FIG. 3B, a voltage (potential) having a rectangular wave (hereinafter referred to as “second rectangular wave”) with an amplitude V2 is applied to the second electrode portion 15. Further, as shown in FIG. 3C, a voltage (potential) having a rectangular wave (hereinafter referred to as “third rectangular wave”) with an amplitude V3 is applied to the second electrode 4.

As shown in FIG. 3A and FIG. 3B, the first rectangular wave and the second rectangular wave have the same phase, and as shown in FIG. 3C, the third rectangular wave has a phase different from those of the first rectangular wave and the second rectangular wave by 180°.

As described above, a drive voltage for the liquid crystal lens 1 can be reduced to the extent possible by inverting the phase of the third rectangular wave with respect to those of the first rectangular wave and the second rectangular wave. That is, a voltage difference (potential difference) between the first electrode portion 14 of the first substrate 3 and the second electrode 4 of the second substrate 5 can be set to V1-V3 through use of the third rectangular wave with the inverted phase. Similarly, a voltage difference (potential difference) between the second electrode portion 15 of the first substrate 3 and the second electrode 4 of the second substrate 5 can be set to V2-V3.

That is, as compared to the case in which the second electrode 4 is set to a ground electrode as in the related art, a voltage between the first electrode 2 and the second electrode 4 can be reduced by applying the voltage V3 having the third rectangular wave with the inverted phase through use of the third power supply 18. For example, when it is assumed that V1, V2, and V are 100 Vrms, 60 Vrms, and GND, respectively, in the case where the second electrode 4 is set to a ground electrode as in the related art, V1, V2, and V3 are set to +50 Vrms, +10 Vrms, and −50 Vrms (symbols “+” and “−” each represent a voltage state at the same time), respectively, in order to generate the same electric field by the liquid crystal lens 1 according to the first embodiment. Thus, the drive voltage (maximum value) can be reduced to ½ as compared to the related art through use of the liquid crystal lens 1 according to the first embodiment.

As described above, only the drive voltage for the liquid crystal lens 1 can be reduced without decreasing the optical power thereof. Thus, a load of a circuit configured to drive the liquid crystal lens 1 can be reduced to the extent possible, which significantly contributes to downsizing of a device in which the liquid crystal lens 1 is incorporated.

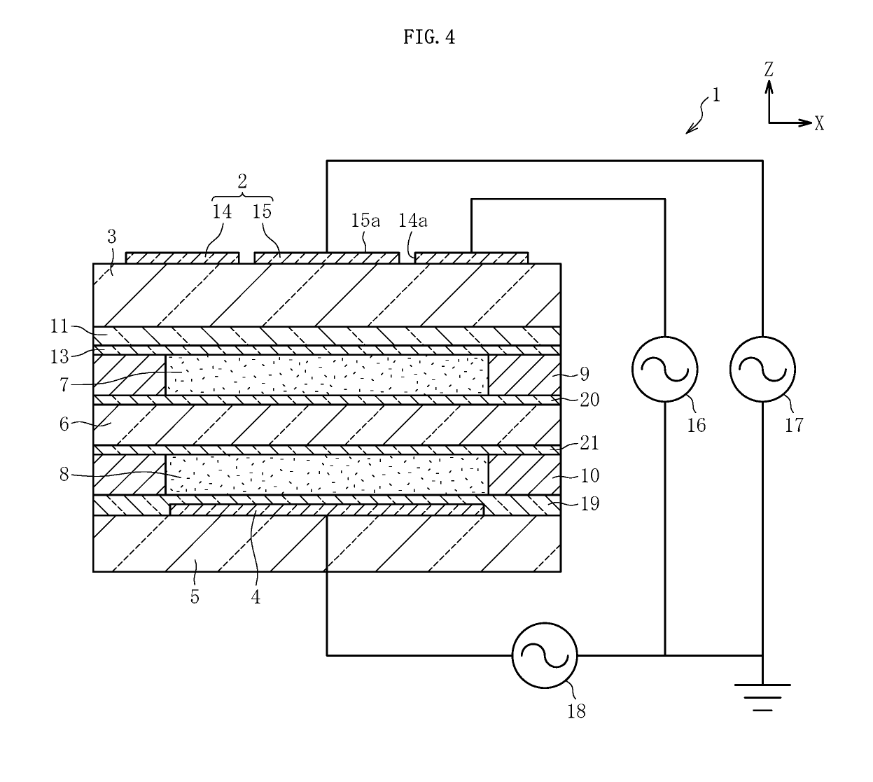

FIG. 4 is a view for illustrating a liquid crystal lens according to a second embodiment of the present invention. In the first embodiment, the liquid crystal lens 1 comprising the high-resistance film 12 is exemplified, but the liquid crystal lens 1 according to the second embodiment does not have the high-resistance film 12. Specifically, the first substrate 3 has the first electrode 2 on one surface, with the other surface being arranged so as to be opposed to the second electrode 4 on the second substrate 5.

That is, the liquid crystal lens 1 according to the second embodiment has the first substrate 3 interposed between the first electrode 2 and the second electrode 4. Even with such a configuration, the liquid crystal lens 1 can be driven with a low voltage by applying the voltages V1 and V2 having the first rectangular wave and the second rectangular wave with the same phase to the first electrode portion 14 and the second electrode portion 15 through use of the first power supply 16 and the second power supply 17, respectively, and applying the voltage V3 having the third rectangular wave with the inverted phase (the phase different by 180°) to the second electrode 4 through use of the third power supply 18.

The present invention is not limited to the configurations of the above-mentioned embodiments. In addition, the action and effect of the present invention are not limited to those described above. The present invention may be modified in various forms within the range not departing from the spirit of the present invention.

In the above-mentioned embodiments, the liquid crystal lens 1 comprising the first substrate 3, the second substrate 5, and the third substrate 6 is exemplified, but the present invention is not limited thereto. For example, the liquid crystal lens 1 may comprise the first substrate 3, the second substrate 5, the first liquid crystal layer 7, and the first spacer 9 with the third substrate 6, the second liquid crystal layer 8, and the second spacer 10 being omitted.

### REFERENCE SIGNS LIST

1 liquid crystal lens

2 first electrode

4 second electrode

7 first liquid crystal layer (liquid crystal layer)

8 second liquid crystal layer (liquid crystal layer)

12 high-resistance film

14 first electrode portion

14a opening

15 second electrode portion

16 first power supply

17 second power supply

18 third power supply

1. A liquid crystal lens, comprising:
a first electrode comprising:
a first electrode portion having a circular opening; and
a second electrode portion arranged on an inner side of the circular opening;
a second electrode opposed to the first electrode;
a liquid crystal layer formed between the first electrode and the second electrode; and
power supplies configured to apply an AC voltage to the first electrode and the second electrode,
the power supplies comprising:
a first power supply configured to apply a voltage having a first rectangular wave to the first electrode portion;
a second power supply configured to apply a voltage having a second rectangular wave with a phase identical to a phase of the first rectangular wave to the second electrode portion; and
a third power supply configured to apply a voltage having a third rectangular wave with a phase different from the phase of the first rectangular wave and the phase of the second rectangular wave by 180° to the second electrode.

2. The liquid crystal lens according to claim 1, further comprising a high-resistance film formed between the first electrode and the liquid crystal layer.

3. The liquid crystal lens according to claim 1, further comprising a substrate comprising the first electrode,
wherein the substrate is interposed between the first electrode and the second electrode.
